(19) United States
(12) Patent Application Publication
(10) Pub. No.: US 2023/0031633 A1
(43) Pub. Date: Feb. 2, 2023

(54) INTELLIGENT PREDICTION OF MEETING AVAILABILITY

(71) Applicant: Zoom Video Communications, Inc., San Jose, CA (US)

(72) Inventor: Shane Paul Springer, Manchester, MI (US)

(21) Appl. No.: 17/390,698

(22) Filed: Jul. 30, 2021

(51) Int. Cl. G06N 5/04

(52) U.S. Cl. CPC G06N 5/04

(57) ABSTRACT

Methods and systems provide for predicting meeting availability for a user. First the system receives a calendar associated with a user of a communication platform, information associated with past requested meetings, and a user behavioral profile associated with the user. The system determines an earliest available time slot for a requested meeting. Next, the system determines that one or more scheduled future meetings are scheduled earlier than the earliest available time slot for the future meeting. For each scheduled future meeting, the system identifies one or more similar past meeting requests based on the scheduled future meeting exceeding a similarity threshold with respect to the past requested meetings; analyzes the user behavioral profile with respect to the similar past meeting requests; and generates an availability prediction score for the scheduled future meeting. Finally, the system provides one or more predicted available times for the user to attend the requested meeting based on the availability prediction scores.

### FIELD OF INVENTION

The present invention relates generally to digital communication, and more particularly, to systems and methods for intelligently predicting meeting availability for a user within a communication platform.

### BACKGROUND

Digital communication tools and platforms have been essential in providing the ability for people and organizations to communicate and collaborate remotely, e.g., over the internet. In particular, there has been massive adopted use of communication platforms allowing for remote video sessions between multiple participants. Communications applications for casual friendly conversation (“chat”), webinars, large group meetings, work meetings or gatherings, asynchronous work or personal conversation, and more have exploded in popularity.

With the ubiquity and pervasiveness of remote video conversations, users of such communication platforms frequently find themselves in back-to-back scheduled meetings throughout the day. Some users may have remote work meetings or other commitments booked constantly during work hours for a week or even several weeks in advance. While scheduling services, auto-scheduling services, and other scheduling and booking products and services provide convenience in booking the earliest available time slot to meet with a person, they provide no way to book a time slot that is currently filled with another meeting or event, but which that person is unlikely to attend or considers optional, etc. Such scheduling services have no visibility into the behaviors and preferences of a user during meetings, which meetings the user attends and which he does not, when the user participates in a meeting and when he does not, and other behaviors and preferences which provide insight into whether an earlier time slot that appears as booked on a calendar may still be reservable.

### BRIEF DESCRIPTION OF THE DRAWINGS

The present invention relates generally to digital communication, and more particularly, to systems and methods providing for intelligently predicting meeting availability for a user within a communication platform.

The present disclosure will become better understood from the detailed description and the drawings, wherein:

FIG. 1A is a diagram illustrating an exemplary environment in which some embodiments may operate.

FIG. 1B is a diagram illustrating an exemplary computer system that may execute instructions to perform some of the methods herein.

FIG. 2 is a flow chart illustrating an exemplary method that may be performed in some embodiments.

FIG. 3 is a diagram illustrating one example embodiment of a UI for scheduling a meeting within a communication platform, according to some embodiments.

FIG. 4 is a diagram illustrating one example embodiment of a UI for setting desired working hours for a scheduling UI within a communication platform, according to some embodiments.

FIG. 5 is a diagram illustrating an exemplary computer that may perform processing in some embodiments.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

There is a need in the field of digital communication tools and platforms to create a new and useful system and method for intelligently predicting meeting availability for a user within a communication platform. The source of the problem, as discovered by the inventors, is a lack of ability to predict time slots for meeting scheduling which are currently reserved for meetings or other events, but which are nevertheless reservable because that meeting or event is considered skippable or optional by the would-be attendee.

The invention overcomes the existing problems by enabling the ability for users of a communication platform to book meetings with other users by reserving time slots which appear to be booked for one or more invitees to the meeting, but which the invitees are predicted to likely not attend for one or more reasons.

In one embodiment, a method is provided for predicting meeting availability for a user. First the system receives: a calendar associated with a user of a communication platform, which includes a schedule of one or more scheduled future meetings on the communication platform; information associated with a plurality of past requested meetings on the communication platform; and a user behavioral profile associated with the user, comprising a plurality of user behaviors associated with the past requested meetings. The system also receives a meeting request for the user, and determines an earliest available time slot for the requested meeting. Next, the system determines that one or more of the scheduled future meetings are scheduled earlier than the earliest available time slot for the future meeting. For each of the one or more scheduled future meetings which are earlier than the earliest available meeting time slot, the system deploys an artificial intelligence (AI) model to: identify one or more similar past meeting requests based on the scheduled future meeting exceeding a similarity threshold with respect to one or more past requested meetings; analyze the user behavioral profile with respect to the one or more similar past meeting requests; and based on the analysis of the user behavioral profile, generate an availability prediction score for the scheduled future meeting, the availability prediction score indicating a likeliness of the user being available for the requested meeting during the time slot for the scheduled future meeting. Finally, the system provides one or more predicted available times for the user to attend the requested meeting based on the availability prediction scores for the one or more scheduled future meetings.

Further areas of applicability of the present disclosure will become apparent from the remainder of the detailed description, the claims, and the drawings. The detailed description and specific examples are intended for illustration only and are not intended to limit the scope of the disclosure.

By way of illustration of the systems and methods described herein, a salesperson may want to have an account with a customer relationship management (CRM) platform closed. In order to close their account, however, the salesperson needs an issue resolved via a meeting with a service agent for the CRM platform. In order to book a meeting with the service agent, the CRM platform uses an auto-scheduling service to allow the salesperson to book the meeting. Upon opening the auto-scheduling service, however, the salesperson discovers that the service agent is fully booked until the next Thursday, which is a week and a half away. With previous systems and methods, the salesperson would have no recourse except to book the meeting for next Thursday.

Using the present systems and methods, however, the scheduling service determines that at this Thursday at 3 pm, there is a recurring meeting that the service agent is booked for but never attends. Furthermore, at 3 pm today, there is a recurring meeting that the service agent attends half the time, and when they do attend, they remain on mute throughout the meeting, without ever participating. There is thus some likelihood that the service agent will be able to join the meeting for today, and a much greater likelihood that the service agent will be able to join the meeting on Thursday. The scheduling service confirms with the service agent that he can meet with the salesperson at 3 pm today and skip today's previously booked meeting. The meeting is then scheduled, and the salesperson will be able to resolve the issue and close their account the very same day, which is a much better outcome than waiting a week and a half for the next unreserved time slot.

I. Exemplary Environments

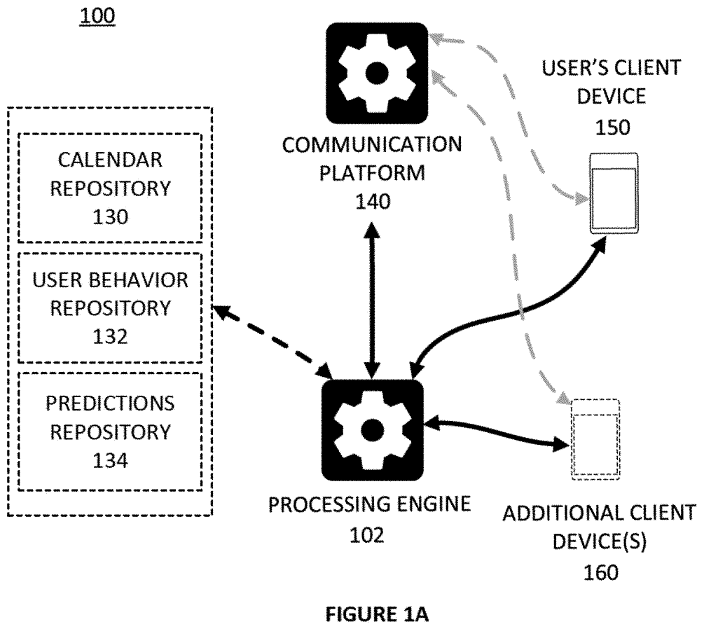

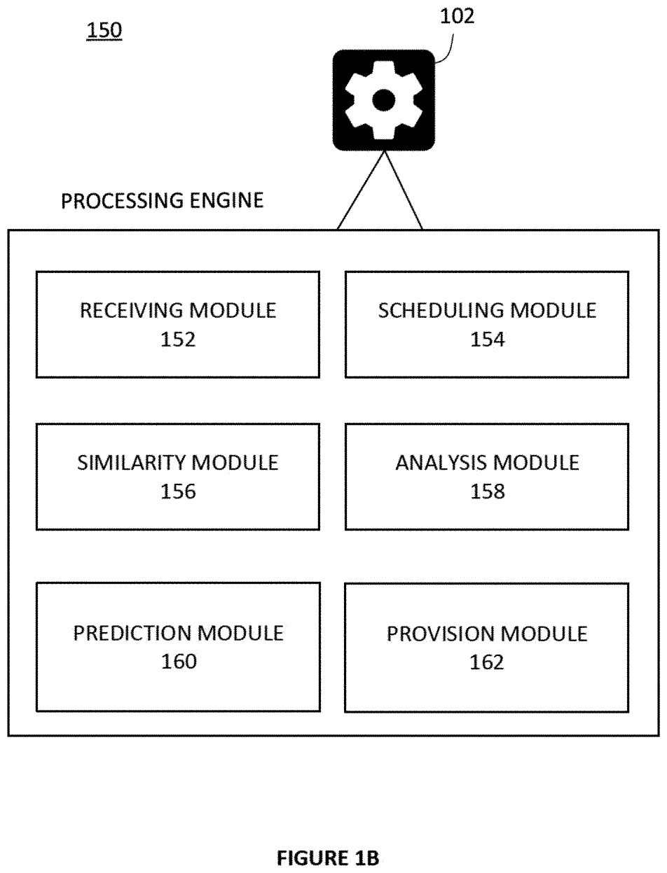

FIG. 1A is a diagram illustrating an exemplary environment in which some embodiments may operate. In the exemplary environment 100, a user's client device 150 and one or more additional client device(s) 160 are connected to a processing engine 102 and, optionally, a communication platform 140. The processing engine 102 is connected to the communication platform 140, and optionally connected to one or more repositories and/or databases, including, e.g., a calendar repository 130, user behavior repository 132, and/or a predictions repository 134. One or more of the databases may be combined or split into multiple databases. The user's client device 150 and additional client device(s) 160 in this environment may be computers, and the communication platform 140 and processing engine 102 may be applications or software hosted on a computer or multiple computers which are communicatively coupled via remote server or locally.

The exemplary environment 100 is illustrated with only one additional user's client device, one processing engine, and one communication platform, though in practice there may be more or fewer additional client devices, processing engines, and/or communication platforms. In some embodiments, the client device(s), processing engine, and/or communication platform may be part of the same computer or device.

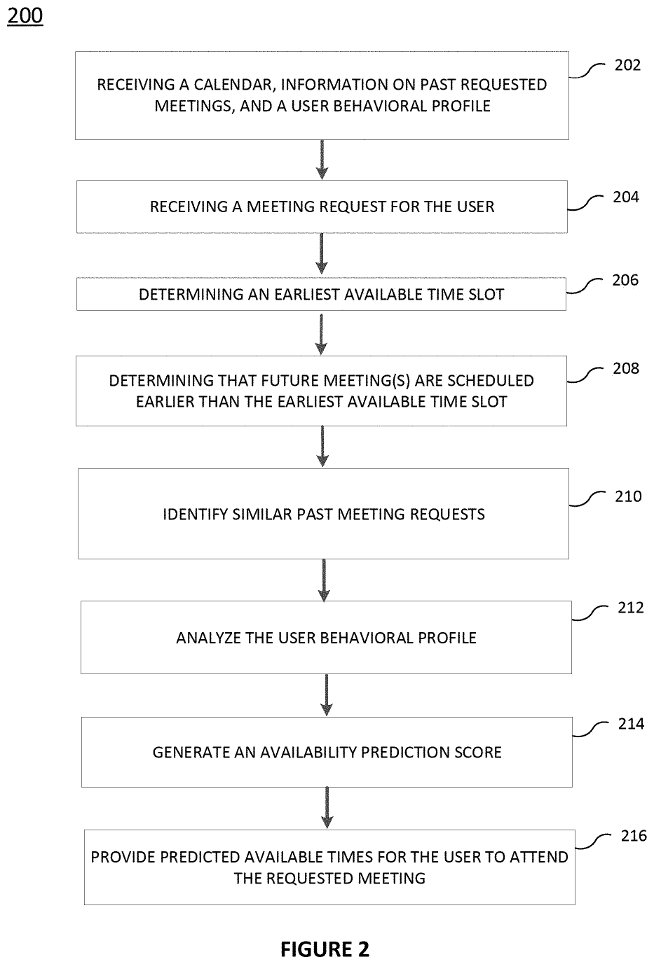

In an embodiment, the processing engine 102 may perform the exemplary method of FIG. 2 or other method herein and, as a result, provide for intelligently predicting meeting availability for a user within a communication platform. In some embodiments, this may be accomplished via communication with the user's client device, additional client device(s), processing engine, communication platform, and/or other device(s) over a network between the device(s) and an application server or some other network server. In some embodiments, the processing engine 102 is an application, browser extension, or other piece of software hosted on a computer or similar device, or is itself a computer or similar device configured to host an application, browser extension, or other piece of software to perform some of the methods and embodiments herein.

The user's client device 150 and additional client device(s) 160 are devices with a display configured to present information to a user of the device. In some embodiments, the client devices present information in the form of a user interface (UI) with multiple selectable UI elements or components. In some embodiments, the client devices 150 and 160 are configured to send and receive signals and/or information to the processing engine 102 and/or communication platform 140. In some embodiments, the client devices are computing devices capable of hosting and executing one or more applications or other programs capable of sending and/or receiving information. In some embodiments, the client device may be a computer desktop or laptop, mobile phone, virtual assistant, virtual reality or augmented reality device, wearable, or any other suitable device capable of sending and receiving information. In some embodiments, the processing engine 102 and/or communication platform 140 may be hosted in whole or in part as an application or web service executed on the client devices 150 and/or 160. In some embodiments, one or more of the communication platform 140, processing engine 102, and client devices 150 and 160 may be the same device. In some embodiments, the user's client device 150 is associated with a first user account within a communication platform, and the additional client device(s) 160 are associated with additional user account(s) within a communication platform.

In some embodiments, optional repositories can include one or more of a calendar repository 130, user behavior repository 132, and/or predictions repository 134. The optional repositories function to store and/or maintain, respectively, calendar information associated with a user of the communication platform 140, including a schedule of one or more scheduled future meetings for the user on the communication platform; user behaviors detected or identified for a user within the communication platform; and predictions relating to meeting availability within the communication platform, including availability prediction scores. The optional database(s) may also store and/or maintain any other suitable information for the processing engine 102 or communication platform 140 to perform elements of the methods and systems herein. In some embodiments, the optional database(s) can be queried by one or more components of system 100 (e.g., by the processing engine 102), and specific stored data in the database(s) can be retrieved.

Communication platform 140 is a platform configured to facilitate communication between two or more parties, such as within a conversation, video conference or meeting, message board or forum, virtual meeting, or other form of digital communication. The communication session may be one-to-many (e.g., a speaker presenting to multiple attendees), one-to-one (e.g., two friends speaking with one another), or many-to-many (e.g., multiple participants speaking with each other in a group video setting).

FIG. 1B is a diagram illustrating an exemplary computer system 150 with software modules that may execute some of the functionality described herein.

Receiving module functions to receive one or more pieces of data which will be used by the system, including at least a calendar associated with a user of the communication platform, information associated with a number of past requested meetings on the communication platform, a user behavioral profile associated with the user, and notifications of requested meetings for the user.

Scheduling module 154 functions to determine available time slots within the calendar for a requested meeting, as well as to determine that one or more of the scheduled future meetings are scheduled earlier than the earliest available time slot for the future meeting.

Similarity module 156 functions to determine, for each of the scheduled future meetings, whether one or more of the scheduled future meetings are scheduled earlier than the earliest available time slot for the future meeting.

Analysis module 158 functions to analyze the user behavioral profile with respect to the one or more similar past meeting requests.

Prediction module 160 functions to generate an availability prediction score for the scheduled future meeting based on the analysis of the user behavioral profile.

Provision module 162 functions to provide one or more predicted available times for the user to attend the requested meeting based on the availability prediction scores for the one or more scheduled future meetings.

The above modules and their functions will be described in further detail in relation to an exemplary method below.

II. Exemplary Method

FIG. 2 is a flow chart illustrating an exemplary method that may be performed in some embodiments.

At step 202, the system receives a calendar associated with a user of a communication platform, information on past requested meetings, and a user behavioral profile containing user behaviors.

In some embodiments, the calendar associated with the user is a calendar internal to the communication platform. In other embodiments, the calendar is external to the communication platform, and may be developed and/or maintained by a third party. For example, the user may be a participant of the communication platform, and the requested meeting may be in the process of being scheduled on an external third-party calendar. In some embodiments, the communication platform integrates the calendar functionality into the platform, and/or connects to the calendar via a remote network or cloud solution. In some embodiments, the calendar includes a list of dates associated with information about meetings or events scheduled for particular dates, e.g., time and length of meeting, name of meeting, participants, link to the communication platform session for holding the meeting, and any other suitable information for a meeting on a communication platform that has been scheduled. In some embodiments, the calendar is associated with a calendar user interface (UI) presented to one or more users of the communication platform, which contains elements of a calendar with monthly, weekly, and/or daily views, including available time slots for meetings (i.e., time slots for which no other meeting or event has been scheduled). In some embodiments, the calendar is a part of a scheduling UI, auto-scheduling UI, or other calendar-based UI which enables users to book meetings upon easily viewing available time slots for users.

In some embodiments, the information on past requested meetings includes one or more of, e.g., names of past meetings, participants of past meetings, whether the user in question accepted, attended, participated in, or was engaged in the past meetings (as will be described in further detail below), dates and times for past meetings, and any other suitable information about past meetings which may be relevant.

In some embodiments, the user behavioral profile contains user behaviors which have been associated with the user regarding historical behaviors in relation to past meetings. In some embodiments, these user behaviors are detected by the system, generated, and stored in the user behavioral profile. In other behaviors, the user behaviors can be retrieved from one or more other locations, such as a third-party behavioral tracking service, or from the user themselves via one or more UI mechanisms for sharing user behaviors with the system. In some embodiments, the user behaviors constitute insights about how the user behaviors, and their habits and predilections in relation to a myriad of activities within the communication platform.

In some embodiments, at least a subset of the user behaviors associated with past requested meetings relates to accepting or declining the past requested meetings. Whether the user accepted or declined a meeting upon receiving a meeting invite is relevant information in terms of whether the user considers the meeting to be important enough to attend. If the user declined a meeting, the system may determine one or more user behaviors representing common factors or patterns in meetings the user declines. For example, a user may decline meetings with 200 participants or more, but accept meetings with 50 or fewer participants, which creates a pattern which can be used to predict that a user will be likely to continue this pattern when attending meetings or responding to meeting invitations.

In some embodiments, at least a subset of the user behaviors associated with past requested meetings relates to attending or not attending the past requested meetings that have been accepted. In some cases, users may accept a meeting invitation, but then not attend that meeting. User behaviors may be generated containing some predilections of the user for what sorts of meetings the user is likely to accept but not attend. For example, a user may always accept meetings for a weekly social hour, but may only be able to attend the social hour 10% of the time. The user behavior generated may thus reflect this likelihood of attending the social hour. In another example, the user may attend 100% of meetings within their own team, but may accept but not attend 100% of meetings outside of their own team. This is also a user behavior which may be determined and generated.

In some embodiments, at least a subset of the user behaviors associated with past requested meetings relates to the user participating or not participating in the past requested meetings that were attended by the user. In various embodiments, participating can include one or more of, e.g., contributing vocally to the meeting, broadcasting a video feed, screen sharing, document collaboration, and textual messaging within the meeting interface. Such user behaviors may be relevant because even though a user may accept a meeting invitation and even attend the meeting in question, the user may still not participate in the meeting, and may choose to disable both their audio and video broadcasting throughout the full duration of the meeting.

In some embodiments, at least a subset of the user behaviors associated with past requested meetings relates to user engagement within the past requested meetings that were attended by the user. In various embodiments, user engagement can include one or more of, e.g., visual engagement via eye tracking, whether the meeting is within an active window of the user environment, and percentage of the meeting attended. Engagement when attending a meeting is often a good indicator of how important or not important the user considers the meeting to be. For example, a user may be fully engaged during meetings with his supervisor, and this manifests as always having the meeting window as the dominant active window within the user's browser of communication application, expanding the window to better view shared material, having their eyes track aspects of the meeting (thus demonstrating a focused attention on the meeting), and more. Conversely, if the user is attending a 250-person meeting for a department other than the user's own which the user is not interested in engaging with, the user behaviors for that meeting may include, e.g., having the window minimized or not visible on the user's screen, leaving the meeting early (e.g., 50% of the way through the duration of the meeting when other participants remain for the full duration), participating in asynchronous chat or conversation within the communication session, clicking on different elements within the communication session window, and more.

In some embodiments, at least a subset of the user behaviors associated with past requested meetings relates to a likelihood the user will attend a meeting with one or more specific additional users. In some embodiments, the one or more specific additional users are users within a particular hierarchy or subhierarchy of an organization. A user will be more likely to consider a meeting important and unmissable if their direct supervisor attends the meeting, for example, or if one of the colleagues they work closely with daily is hosting a meeting. In some embodiments, the system can receive hierarchical, sub-hierarchical, or other organizational information with respect to a user of the communication platform, and use this information to determine new user behaviors for users with respect to attending meetings within that organizational hierarchy.

For example, a user may be part of a premium business account within the communication platform that includes all employees of the organization. The organization provides information to the communication platform about the organizational hierarchy of that organization, includes names of users and their place within the hierarchy. The system can then use this information to determine relevant insights about user behavior. In some embodiments, the system may determine that the closer a user is to another user within the organizational structure, the more likely they will be to attend the meeting, with the exception of, e.g., meetings hosted by the head of the organization or a leading executive of the organization.

In some embodiments, at least a subset of the user behaviors associated with the past requested meetings relate to recurring meetings. Such recurring scheduled meetings can lead to important insights about user behavior with respect to that set of recurring meetings as well as other types of recurring meetings with may share similar qualities (e.g., same or similar participants, same departments, same subject matter, etc.) One example of a user behavior may be that a user has accepted all future recurring meetings for a particular weekly meeting, but never attends the meetings, or is never engaged nor participating within the meeting. In such a case, it is likely that the user does not consider the meeting unmissable, and would accept another, more important meeting that is scheduled for the same time slot.

At step 204, the system receives a meeting request for the user. In some embodiments, receiving a meeting request involves receiving input from an additional user of the communication platform within a scheduling interface, the input relating to scheduling the requested meeting within the calendar of at least the user.

In some embodiments, receiving the meeting request for the user includes: receiving a message for the user related to a requested meeting; sending, to the user, the message and an option to accept or decline the requested meeting; and receiving, from the user, an acceptance of the requested meeting. For example, a scheduling user may send a message, e.g., within a chat or messaging system in the communication platform, or via email, explaining the meeting request. That message would feed into a chat message or email which the receiving user receives. The receiving user can then accept or decline the requested meeting with, e.g., a chat message or email, including reasons for the acceptance or rejection. In some embodiments, this process can be modeled within a user interface in some other way, such as through a series of “cards” or other user interface elements.

In some embodiments, the additional user of the communication platform has been granted permission to schedule meetings on behalf of the user. This can include, for example, an administrator, scheduler, or agent who is allowed to schedule meetings for the user.

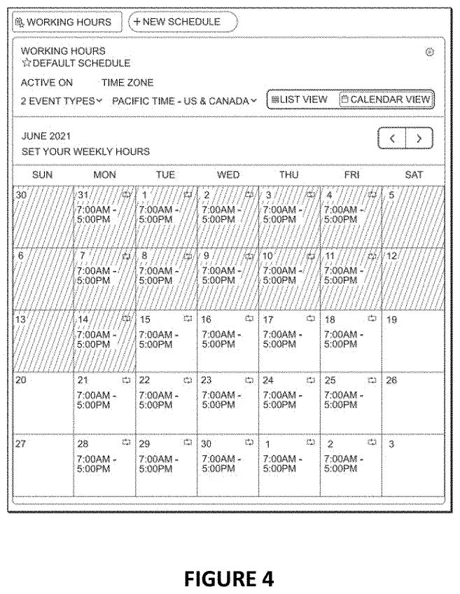

At step 206, the system determines an earliest available time slot for the meeting. In some embodiments, the earliest available time slot is the first available time slot that is not already reserved for another meeting or event within the calendar. In some embodiments, users can specify desired working hours or acceptable times for scheduling meetings. The system will take such times into account when determining the earliest available time. One example of a user interface for establishing or configuring desired working hours in a scheduling interface is illustrated in FIG. 4, which will be described in detail further blow.

At step 208, the system determines that one or more scheduled future meetings are scheduled earlier than the earliest available time slot of the future meeting. In this step, the system determines whether there have been any meetings that were scheduled for earlier than the earliest available time for scheduling a meeting. For example, the earliest available time for a meeting may be Thursday at 3 pm. However, there are some earlier meetings, including one meeting on Wednesday at 4 pm and another on Wednesday at 1 pm. The system determines that there are earlier scheduled meetings and classifies them such.

At step 210, for each scheduled future meeting, the system identifies one or more similar past meeting requests based on the scheduled future meeting exceeding a similarity threshold with respect to one or more past requested meetings. In some embodiments, a similarity threshold may be a predefined, pre-established threshold for identifying within the system which scheduled future meetings can be considered sufficiently similar to previous meetings that the user has attended. In some embodiments, a similarity threshold may be a correlation coefficient which indicates whether, e.g., meetings can be considered highly correlated or not very correlated at all. In some embodiments, determining that the future meeting meets or exceeds a similarity threshold involves determining that the future meeting is a recurring meeting that has been requested for the user at least once before. In some embodiments, rather than the similarity threshold being a predefined or pre-established threshold, it is dynamically determined based on one or more factors, with different users potentially having different similarity thresholds based on, e.g., user behaviors, organizational title or hierarchical position, department, or other relevant factors.

For example, one recurring meeting of a user may be to meet every Tuesday with Vendor A. A recurring user behavior is established within the user behavioral profile such that every Tuesday, the user will meet with some vendors. This user behavior is generated based on this recurring meeting, as well as other hallmarks (e.g., other user behaviors) that this behavior matches the profile. In some embodiments, the AI model is able to generate such a user behavior. For example, if the hardware partnerships team within the user's organization is on the invite, then the AI model may determine that the meeting is likely to be a hardware partnership meeting with a vendor. In some embodiments, the AI model is capable of predicting recurring user behavior based on such information, and may not need any additional external information to generate the user behavior.

In some embodiments, the system deploys an artificial intelligence (“AI”) model to perform one or more of steps 210, 212, and 214 of FIG. 2. The AI model may include AI-based processes and techniques, such as, e.g., machine learning or deep learning. In some embodiments, the AI model utilizes neural networks, such as, e.g., convolutional neural networks (“CNNs”), recurrent neural networks (“RNNs”) long short term memory (“LSTM”), and deep neural networks (“DNNs”). In some embodiments, the AI model can be trained on datasets relating to users, past meetings, previous predictions for availability meeting times, and more. In some embodiments, the AI model is trained on at least one or more datasets comprising user behavioral profiles for users of the communication platform with respect to past requested meetings. In some embodiments, the AI model is trained based on whether predicted available times that were selected for requested meetings were times in which users actually attended the requested meetings.

At step 212, for each scheduled future meeting, the system analyzes the user behavioral profile with respect to the one or more similar past meeting requests. As mentioned above, in some embodiments, the analysis is performed via an AI model which the system deploys. In some embodiments, the AI model is trained to classify or predict values relating to user behaviors from the user behavioral profile as well as the similar past requested meetings. If a user behaved in a certain way with respect to past requested meetings that are similar to the meeting that the system is trying to determine the importance of, then the user is likely to behave in similar ways with respect to the meeting. For example, if meetings hosted by a certain department are always accepted but never attended, then there is a high likelihood that the meeting in question, which is also hosted by the department and was accepted by the user, will also not be attended. The system analyzes the user behavioral profile and similar past requested meetings to generate such connections and/or likelihood values between past meetings and the meeting in question.

At step 214, for each scheduled future meeting, the system generates an availability prediction score based on the analysis of the user behavioral profile. The availability prediction score functions as a confidence score with regard to how likely it is that the user will be available during this slot to attend another meeting, even though there is a conflict on the user's calendar with another meeting or event. The analysis from step 212 is used to generate the prediction score based on whether past similar meetings had previous behaviors associated with them that point toward attending or not attending the current meeting (e.g., the user accepted or didn't accept, the user attended or didn't attend, the user participated or didn't participate, the user was engaged during the meeting or not, etc.) As mentioned above, in some embodiments, the availability prediction score is generated via an AI model which the system deploys. A consistent system or metric is employed by the AI model such that availability prediction scores are all generated with the same metrics, and can be readily compared to one another or ranked for various purposes.

At step 216, the system provides predicted available times to attend the requested meeting based on the availability prediction scores. In some embodiments, these predicted available times can be selected by a user booking a meeting to select one of the times to book the meeting. In various embodiments, the predicted available times can be sorted, ranked, and/or categorized in different ways according to different needs of the system and/or users. In some embodiments, the one or more predicted available times are provided in descending order of predicted availability score. This allows a user booking a meeting to quickly get a visual sense of which predicted available times are most likely to actually be available. For example, a predicted available time with an 85% availability prediction score (i.e., 85% confidence from the AI model that the user will be available to attend) is listed before a second predicted available time with a 35% availability prediction score.

In some embodiments, the one or more predicted available times are provided in chronological order (i.e., from first in time to last in time). In some embodiments, a rating can be assigned to each of the predicted available times. The scheduling user and/or the user receiving predicted available times for meetings can rate the predicted available times in order of preference or by some other system of rating. In some embodiments, the times can then be sorted by rating, or the ratings can be otherwise easily viewable within the chronological ordering.

In some embodiments, the scores are listed for the user booking the meeting, while in other embodiments they are not to provide some privacy to the user associated with the calendar. In some embodiments, the names and/or participants of the meetings associated with the predicted available times are not listed as well, also to provide privacy.

In some embodiments, rather than listing predicted available times in order of prediction score, they are listed in order of earliest predicted time available. Thus, a time with 35% availability prediction score that is this afternoon will be listed before a time with 85% availability prediction score that is next week. In some embodiments, a hybrid of chronological time and prediction availability score are used in sorting and ranking the times from first to last.

In some embodiments, the system provides, to the user via the user client device, a decision digest comprising one or more decisions for scheduling requested meetings based on predicted available times for the requested meetings. In some embodiments, rather than listing predicted available times for a user booking a meeting to select from, the system “auto-schedules” the meeting for the user, then provides the decision digest to the user associated with the calendar, informing that user of one or more decisions the system made in booking meetings at the same time as other meetings or events the user already has scheduled in his calendar. Thus, even though the meetings were auto-scheduled to conflict with other meetings or events, the user is provided with a digest of such scheduled meetings. In some embodiments, the user can quickly select an option to accept or decline the newly scheduled meeting at a glance within the digest. Thus, the user can be empowered to make decisions regarding these conflicts within an easy, consolidated format. In some embodiments, the digest may be configured either by default or by the user to be presented to the user daily, weekly, monthly, or at any other interval.

In some embodiments, the decision digest further includes one or more reasons for why the predicted available time was provided for the requested meeting. In some embodiments, there may be a messaged associated with each scheduling decision. For example, a message may read, “we think this is a good invitation, because: you never join the recurring meeting which conflicts with this scheduled meeting.” The user can then look in his calendar and check the details of the meeting, understand the conflict, and accept or decline the scheduling decision based on this information.

In some embodiments, one or more user behaviors with respect to the predicted available times are fed back into the AI model to improve generation of future availability prediction scores. Decision feeds back into the AI model (whether user says yes or no). For example, if a user is scheduled for a requested meeting at one of the predicted available times, and the user only attends 30% of the meeting, then that user behavior with respect to amount or percentage of time attended is fed back into the AI model (e.g., through a closed-loop reinforcement learning circuit or similar process). The AI model then uses this information to generate improved predictions for future availability prediction scores.

In some embodiments, the system receives notification that the user declined the one or more predicted available times for the meeting. The user then sends, to the user, a new proposed time and an option to accept or decline the new proposed time. In this way, the system can allow for new times to be proposed when a user cannot attend the meeting during the predicted available times.

In some embodiments, the system determines that an option to inform a host of a previously scheduled meeting about a decision related to the previously scheduled meeting has been enabled. The system then provides notification to the host about the decision. For example, a user may have a one-on-one meeting with his manager. The system receives a meeting request for the user, declines the meeting with the manager, and can then notify the manager with a message such as, e.g., “this was declined because of a decision that was made to schedule another meeting with Customer A in this time slot.” Thus, there can be an option for the host of a previously schedule meeting to be informed when the time slot is chosen for another meeting.

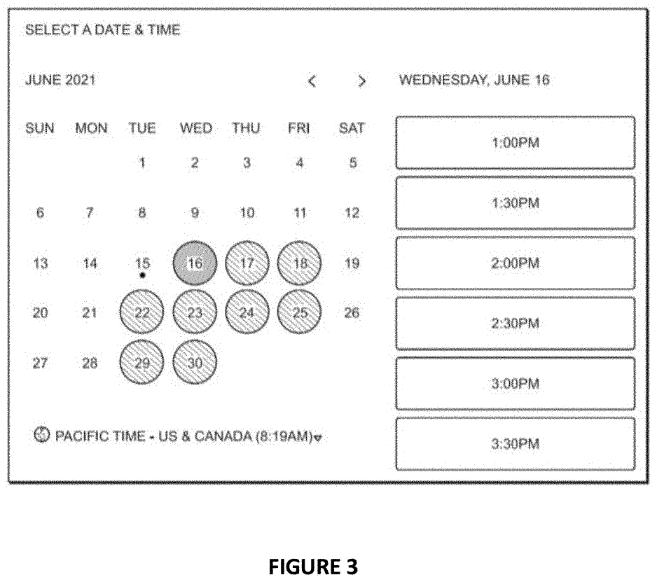

FIG. 3 is a diagram illustrating one example embodiment of a UI for scheduling a meeting within a communication platform, according to some embodiments. A user may encounter this UI via a scheduling service for the communication platform, e.g., either an internal scheduling service within the communication platform, or an external scheduling service connected to or integrated within the communication platform. A calendar element is displayed within the UI, including one or more dates which are marked to indicate that there are selectable or available dates for scheduling a meeting. Upon clicking on a date, available times (e.g., 1:00 pm, 1:30 pm, etc.) are listed which the user can select. In this example embodiment, the user is not informed at all that any of the selectable dates would conflict with other meetings on the invitee's calendar. The user booking the meetings is not exposed to this information, under the reasoning that the user does not need to have any visibility into the other user's calendar details, but rather simply wants to book a meeting for that user. In other embodiments, however, predicted available times can be listed for the user selecting the meeting, so that the user can be made aware of a distinction between time slots which are available with no conflicts and time slots which are predicted to be available even though there is a conflict. In some embodiments, prediction availability scores may also be displayed within this UI for listed predicted available times.

FIG. 4 is a diagram illustrating one example embodiment of a UI for setting desired working hours for a scheduling UI within a communication platform, according to some embodiments. Within the UI, a user associated with a calendar can opt to configure the calendar such that certain designated working hours or desired hours can be set. In some embodiments, these hours can be set on a weekly or, potentially, daily basis. These working hours designate time ranges for which meetings and events can be booked or auto-booked for that user. Within a scheduling UI such as the one from FIG. 3, hours outside of the designated working hours will not be available for booking meetings or events. In some embodiments, a user can additionally or alternatively set designated non-working hours for which meetings or events cannot be booked.

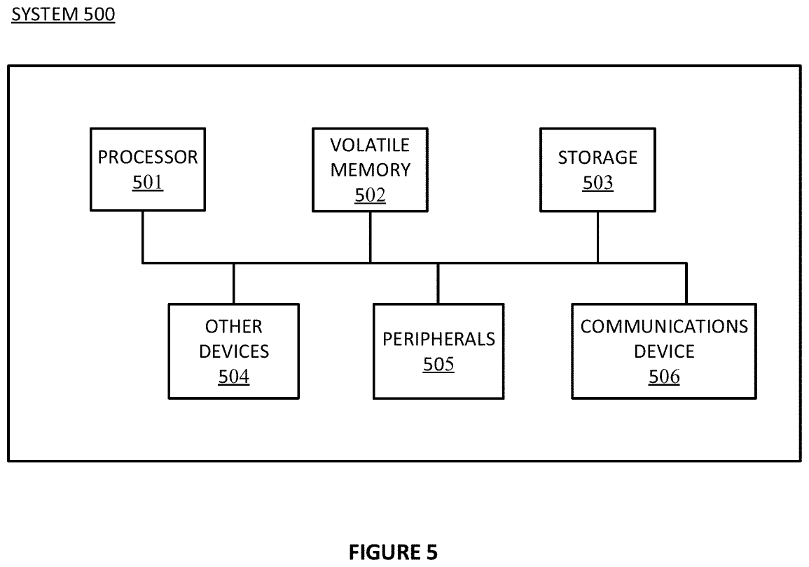

FIG. 5 is a diagram illustrating an exemplary computer that may perform processing in some embodiments. Exemplary computer 500 may perform operations consistent with some embodiments. The architecture of computer 500 is exemplary. Computers can be implemented in a variety of other ways. A wide variety of computers can be used in accordance with the embodiments herein.

Processor 501 may perform computing functions such as running computer programs. The volatile memory 502 may provide temporary storage of data for the processor 501. RAM is one kind of volatile memory. Volatile memory typically requires power to maintain its stored information. Storage 503 provides computer storage for data, instructions, and/or arbitrary information. Non-volatile memory, which can preserve data even when not powered and including disks and flash memory, is an example of storage. Storage 503 may be organized as a file system, database, or in other ways. Data, instructions, and information may be loaded from storage 503 into volatile memory 502 for processing by the processor 501.

The computer 500 may include peripherals 505. Peripherals 505 may include input peripherals such as a keyboard, mouse, trackball, video camera, microphone, and other input devices. Peripherals 505 may also include output devices such as a display. Peripherals 505 may include removable media devices such as CD-R and DVD-R recorders/players. Communications device 506 may connect the computer 100 to an external medium. For example, communications device 506 may take the form of a network adapter that provides communications to a network. A computer 500 may also include a variety of other devices 504. The various components of the computer 500 may be connected by a connection medium such as a bus, crossbar, or network.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A method for predicting meeting availability for a user, comprising:
receiving:
a calendar associated with a user of a communication platform, comprising a schedule of one or more scheduled future meetings on the communication platform,
information associated with a plurality of past requested meetings on the communication platform, and
a user behavioral profile associated with the user, comprising a plurality of user behaviors associated with the past requested meetings;
receiving a meeting request for the user;
determining an earliest available time slot for the requested meeting;
determining that one or more of the scheduled future meetings are scheduled earlier than the earliest available time slot for the future meeting;
for each of the one or more scheduled future meetings which are earlier than the earliest available meeting time slot, deploying an artificial intelligence (AI) model to:
identify one or more similar past meeting requests based on the scheduled future meeting exceeding a similarity threshold with respect to one or more past requested meetings,
analyze the user behavioral profile with respect to the one or more similar past meeting requests, and
based on the analysis of the user behavioral profile, generate an availability prediction score for the scheduled future meeting, the availability prediction score indicating a likeliness of the user being available for the requested meeting during the time slot for the scheduled future meeting; and
providing one or more predicted available times for the user to attend the requested meeting based on the availability prediction scores for the one or more scheduled future meetings.

2. The method of claim 1, wherein one or more user behaviors with respect to the predicted available times are fed back into the AI model to improve generation of future availability prediction scores.

3. The method of claim 1, further comprising:
receiving notification that the user declined the one or more predicted available times for the meeting; and
sending, to the user, a new proposed time and an option to accept or decline the new proposed time.

4. The method of claim 1, wherein at least a subset of the user behaviors associated with past requested meetings relates to accepting or declining the past requested meetings.

5. The method of claim 1, wherein at least a subset of the user behaviors associated with past requested meetings relates to attending or not attending the past requested meetings that have been accepted.

6. The method of claim 1, wherein at least a subset of the user behaviors associated with past requested meetings relates to the user participating or not participating in the past requested meetings that were attended by the user.

7. The method of claim 6, wherein participating comprises one or more of: contributing vocally to the meeting, broadcasting a video feed, screen sharing, document collaboration, and textual messaging within the meeting interface.

8. The method of claim 1, wherein at least a subset of the user behaviors associated with past requested meetings relates to user engagement within the past requested meetings that were attended by the user.

9. The method of claim 8, wherein user engagement comprises one or more of: visual engagement via eye tracking, whether the meeting is within an active window of the user environment, and percentage of the meeting attended.

10. The method of claim 1, wherein at least a subset of the user behaviors associated with past requested meetings relates to likelihood the user will attend a meeting with one or more specific additional users, wherein the one or more specific additional users are users within a particular hierarchy or subhierarchy of an organization.

11. The method of claim 1, wherein the one or more predicted available times are provided in one of: descending order of predicted availability score; or chronological order wherein a rating can be assigned to each of the predicted available times.

12. The method of claim 1, wherein the AI model is trained on at least one or more datasets comprising user behavioral profiles for users of the communication platform with respect to past requested meetings.

13. The method of claim 1, wherein the AI model is trained based on whether predicted available times that were selected for requested meetings were times in which users actually attended the requested meetings.

14. The method of claim 1, further comprising:
providing, to the user, a decision digest comprising one or more decisions for scheduling requested meetings based on predicted available times for the requested meetings.

15. The method of claim 14, further comprising:
determining that an option to inform a host of a previously scheduled meeting about a decision related to the previously scheduled meeting has been enabled; and
providing notification to the host about the decision related to the previously scheduled meeting.

16. The method of claim 1, wherein receiving the meeting request for the user comprises:
receiving input from an additional user of the communication platform within a scheduling interface, the input relating to scheduling the requested meeting within the calendar of at least the user.

17. The method of claim 1, wherein receiving the meeting request for the user comprises:
receiving a message for the user related to a requested meeting;
sending, to the user, the message and an option to accept or decline the requested meeting; and
receiving, from the user, an acceptance of the requested meeting.

18. The method of claim 1, wherein determining that the future meeting meets or exceeds a similarity threshold comprises determining that the future meeting is a recurring meeting that has been requested for the user at least once before.

19. A communication system comprising one or more processors configured to perform the operations of:
receiving:
a calendar associated with a user of a communication platform, comprising a schedule of one or more scheduled future meetings on the communication platform,
information associated with a plurality of past requested meetings on the communication platform, and
a user behavioral profile associated with the user, comprising a plurality of user behaviors associated with the past requested meetings;
receiving a meeting request for the user;
determining an earliest available time slot for the requested meeting;
determining that one or more of the scheduled future meetings are scheduled earlier than the earliest available time slot for the future meeting;
for each of the one or more scheduled future meetings which are earlier than the earliest available meeting time slot, deploying an artificial intelligence (AI) model to:
identify one or more similar past meeting requests based on the scheduled future meeting exceeding a similarity threshold with respect to one or more past requested meetings,
analyze the user behavioral profile with respect to the one or more similar past meeting requests, and
based on the analysis of the user behavioral profile, generate an availability prediction score for the scheduled future meeting, the availability prediction score indicating a likeliness of the user being available for the requested meeting during the time slot for the scheduled future meeting; and
providing one or more predicted available times for the user to attend the requested meeting based on the availability prediction scores for the one or more scheduled future meetings.

20. A non-transitory computer-readable medium containing instructions for predicting meeting availability for a user, comprising:
instructions for receiving:
a calendar associated with a user of a communication platform, comprising a schedule of one or more scheduled future meetings on the communication platform,
information associated with a plurality of past requested meetings on the communication platform, and
a user behavioral profile associated with the user, comprising a plurality of user behaviors associated with the past requested meetings;
instructions for receiving a meeting request for the user;
instructions for determining an earliest available time slot for the requested meeting;
instructions for determining that one or more of the scheduled future meetings are scheduled earlier than the earliest available time slot for the future meeting;
for each of the one or more scheduled future meetings which are earlier than the earliest available meeting time slot, instructions for deploying an artificial intelligence (AI) model to:
identify one or more similar past meeting requests based on the scheduled future meeting exceeding a similarity threshold with respect to one or more past requested meetings,
analyze the user behavioral profile with respect to the one or more similar past meeting requests, and
based on the analysis of the user behavioral profile, generate an availability prediction score for the scheduled future meeting, the availability prediction score indicating a likeliness of the user being available for the requested meeting during the time slot for the scheduled future meeting; and
instructions for providing one or more predicted available times for the user to attend the requested meeting based on the availability prediction scores for the one or more scheduled future meetings.
